(19) United States
(12) Patent Application Publication
(10) Pub. No.: US 2022/0071179 A1
(43) Pub. Date: Mar. 10, 2022

(54) METHOD FOR ASSEMBLY OF A FISH CAGE, A KIT OF PARTS FOR ASSEMBLING A FISH CAGE AND A FISH CAGE

(71) Applicant: Spring Innovation AS, Stavanger (NO)

(72) Inventor: Alf Reidar Sandstad, Stavanger (NO)

(73) Assignee: Spring Innovation AS, Stavanger (NO)

(21) Appl. No.: 17/291,516

(22) PCT Filed: Nov. 5, 2019
(86) PCT No.: PCT/NO2019/050241

§ 371 Date: May 5, 2021

(30) Foreign Application Priority Data
Nov. 6, 2018 (NO) 20181424

(51) Int. Cl. A01K 61/60

(52) U.S. Cl. CPC A01K 61/60

(57) ABSTRACT

A method is for assembly of a fish cage. The fish cage has a bottom unit having a buoyancy exceeding a weight of the bottom unit. The bottom unit has a body configured impermeable to water. The fish cage further has at least one wall element configured impermeable to water. The method includes providing the bottom unit on a surface of a water body. The method further includes connecting the at least one wall element to the body, thereby defining a spacing impermeably separated from the water body.

### CROSS-REFERENCE TO RELATED APPLICATIONS

This application is the U.S. national stage application of International Application PCT/NO2019/050241, filed Nov. 5, 2019, which international application was published on May 14, 2020, as International Publication WO 2020/096463 in the English language. The International Application claims priority of Norwegian Patent Application No. 20181424, filed Nov. 6, 2018. The international application and Norwegian application are both incorporated herein by reference, in entirety.

### FIELD

The invention relates to a method for assembly of a fish cage. The fish cage comprises a bottom unit having a buoyancy exceeding a weight of the bottom unit. The bottom unit comprises a body configured impermeable to water. The fish cage further comprises at least one wall element configured impermeable to water.

The invention further relates to a kit of parts for assembling a fish cage, an assembled fish cage and use of the fish cage.

### BACKGROUND

The aquaculture industry is faced with several challenges, one being parasites, and in particular salmon louse. A mitigating measure against salmon louse is closed fish cages. These are watertight or essentially watertight cages where the supply of water can be controlled.

Fabrication and transportation of such structures are a demanding task that require dedicated yards and specialized vessel. This contributes to driving up the overall cost of fish cages. In some cases, it might be required to fabricate the fish cage far from the installation site, thus requiring transportation over a long distance.

Solutions for modular fish cages that may be fabricated and transported in pieces to some degree exist. However, these must be assembled onshore or on a vessel prior to being towed out to an installation site or deployed to the sea. Towing is a time-consuming task and deploying an assembled fish cage at sea requires vessels with large lifting capacity. Thus, there is a need for a less cost and time-consuming way and a simpler way of assembling a fish cage at sea.

Document WO 2010/099590 discloses a floating closed-containment tank for cultivating marine species. The tank is made up of panels forming a bottom portion and a side portion connected to the bottom portion. The panels making up the bottom portion are formed like cake slices and connected to form a circular bottom. A drawback with the prior art is that the tank must be assembled prior to deployment to sea.

### SUMMARY

In particular, a first object of the invention is to provide a method for assembling a fish cage at a location of its intended use. A second object of the invention is to provide a method for assembling a fish cage at reduced cost compared with prior art fish cages.

These objects are obtained by means of a method for assembly of a fish cage, wherein the fish cage comprises:
a bottom unit having a buoyancy exceeding a weight of the bottom unit, wherein the bottom unit comprises a body configured impermeable to water, and
at least one wall element configured impermeable to water, wherein the method comprises:
providing the bottom unit on a surface of a water body;
connecting the at least one wall element to the body, thereby defining a spacing impermeably separated from the water body.

The invention has the effect that a fish cage may be assembled at the intended location of use, for example at the location of an offshore fish farm. This simplifies transportation, which in turn may render it profitable to fabricate the different elements of a fish cage at a yard located far away from the fish farm. The invention has a further effect that assembly may be performed using a smaller crane than would be required for deployment of a preassembled fish cage. When assembled, the fish cage forms a watertight cage for keeping fish. A watertight fish cage reduces the risk of surrounding water with presence of parasites reaching the fish.

The body of the bottom unit expands over an area and may have a circular shape, a hexagonal shape or another shape. In an operable position, the body may form a downwards pointing cone, or an upwards pointing cone, or another shape. The at least one wall element may be arranged along a peripheral portion of the body. When assembled, the at least one wall element forms a continuous wall. Continuous wall meaning a wall that has no open ends and forms a path that starts and ends at the same point. The at least one wall element may be one continuous element, such as a ring, or several wall elements configured to be interconnected such that they form a continuous wall. In one embodiment where there are multiple wall elements, each of the wall elements may be curved such that when assembled they form a circle, or another shape which forms a continuous wall.

The buoyancy of the bottom unit exceeds the weight of the bottom unit such that it floats when placed on water. In an embodiment, the buoyancy of the bottom unit is sufficient to keep the at least one wall element at least partly above a surface of the water after connection of the at least one wall element to the body of the bottom unit.

In an embodiment of the invention, the at least one wall element comprises a first receiving element and the body comprises a second receiving element, wherein the method comprises a step of:
displacing the at least one wall element to the body so that the first receiving element engages with the second receiving element.

By means of the first receiving element and second receiving element, the connection between the at least one wall element and the body is simplified. The first receiving element and the second receiving element forms a rigid connection. The first receiving element and the second receiving element are complementary, such as a male plug and a female receptacle, e.g. a pin and a hole. In an embodiment, the receiving elements are configured such that the at least one wall element is guided in place during engagement between the receiving elements, for example by a pin and a guide such as a slot. In another embodiment, the connection between the body and the at least one wall element may be bolted and/or welded.

In an embodiment of the invention, the method comprises:
lowering the bottom unit and the at least one wall element connected to the body at least partly in the water body by filling water in the spacing.

By lowering the bottom unit and the at least one wall element connected to the body at least partly in the water body, a top portion of the at least one wall element is positioned closer to the water surface, thus reducing a required lifting height of objects to be lifted from a vessel to the fish cage.

The water for filling the spacing may be supplied from various water locations, for example water from the water body surrounding the fish cage or water from a reservoir, e.g. a tank on a vessel. In one embodiment the water may be from a depth substantially below the surface of the water body, for example 50 metre or 100 metre depth. Presence of louse in the water are less likely at these depths.

This embodiment of the invention is also a step in preparing the fish cage for operation. In operation, the spacing will be near filled with water.

In an embodiment of the invention, the method comprises:
altering a draught of the bottom unit and the at least one wall element connected to the body by changing a water level in the spacing.

By changing the water level in the spacing, the draught is altered in a controlled manner as the assembly is gradually lowered or raised by filling or draining the spacing. A speed of lowering may be adjusted by a rate of filling or draining.

In an embodiment of the invention, the bottom unit further comprises one or more buoyancy elements having a controllable buoyancy, wherein the method comprises:
altering a draught of the bottom unit and the at least one wall element connected to the body by controlling the buoyancy of the one or more buoyancy elements.

By controlling the buoyancy of the one or more buoyancy elements, the draught may be altered without changing the water level in the spacing. The draught may also be altered by controlling the buoyancy of the one or more buoyancy elements in addition to changing a water level in the spacing. In an embodiment, the buoyancy elements may be controlled to skew an orientation of the assembly in the water body by adjusting the buoyancy of one buoyancy element more than another.

In an embodiment of the invention, the method further comprises:
connecting at least one further wall element to a wall element already connected to the body.

By connecting at least one further wall element to a wall element already connected to the body, a volume of the spacing is increased. The at least one further wall element may be connected to a top portion of the wall element already connected to the body. In an embodiment, further wall elements may be connected to an already connected wall element, thus increasing the volume of the spacing even further. The at least one further wall element may be connected to the wall element already connected to the body such that the wall elements forms an even surface. An even surface should be understood as there being no angle between the at least one further wall element and the wall element already connected to the body. This also applies to further wall elements connected to an already connected wall element.

In an embodiment of the invention, the method further comprises:
transporting the bottom unit and the at least one wall element to an installation site by means of a vessel.

Transporting the bottom unit and the at least one wall element to an installation site by means of a vessel is cheaper than transporting conventional rigid watertight fish cages. Further, since the fish cage may be assembled on site, thus transported in pieces, the vessel may be smaller than for transportation of conventional fish cages.

In an embodiment of the invention, the method further comprises:
stacking a plurality of bottom units on top of each other onboard a vessel.

By stacking a plurality of bottom units on top of each more fish cages can be transported on the same vessel.

In an embodiment of the invention, the method further comprises:
stacking a plurality of wall elements on top of each and/or next to each other onboard a vessel.

By stacking a plurality of wall elements on top of each and/or next to each other even more fish cages can be transported on the same vessel.

The object of the invention is further obtained by means of a kit of parts for assembling a fish cage, the kit of parts comprising;
a bottom unit having a buoyancy exceeding a weight of the bottom unit, wherein the bottom unit comprises a body being impermeable to water, and
at least one wall element being impermeable to water, the at least one wall being configured to be connected with the body, thereby defining a spacing impermeably separated from a water body.

In contrast to conventional fish cages configured to be assembled, the kit of parts can be assembled on a surface of a water body. The kit of parts has several benefits:
transportation may be performed using smaller vessels as compared to conventional fish cages.
the bottom unit provides a floatable foundation for assembling the fish cage on the water.
the at least one wall element may be displaced, e.g. lifted, by means of a crane from the transportation vessel directly onto the floating bottom unit.

In an embodiment of the invention, the body comprises a first receiving element and the at least one wall element comprises a second receiving element configured to engage with the first receiving element, thereby forming a connection. The first and second receiving element is used to form a rigid connection between the body of the bottom unit and the at least one wall element in an efficient manner.

In an embodiment of the invention, the body comprises a controllable port configured to provide liquid communication between said spacing and the water body. The controllable port allows for controlled water filling or draining of the spacing when the kit of parts is assembled.

In an embodiment of the invention, the bottom unit comprises one or more buoyancy elements having a controllable buoyancy. The buoyancy elements allow for lowering of the assembled kit of parts without filling the spacing with water.

The object of the invention is further obtained by means of a fish cage comprising:
a bottom unit having a buoyancy exceeding a weight of the bottom unit, wherein the bottom unit comprises a body configured impermeable to water, and
at least one wall element configured impermeable to water, the at least one wall element being connected to the body, thereby defining a spacing impermeably separated from a water body.

In an embodiment of the invention, the body comprises a first receiving element and the at least one wall element comprises a second receiving element in engagement with the first receiving element, thereby forming a connection.

In one embodiment of the invention, the fish cage further comprises a controllable port arranged in the body configured to provide liquid communication between the spacing and the water body. The controllable port allows for controlled water filling or draining of the spacing from a bottom and upwards. In another embodiment, the port is arranged in the at least one wall element. In a further embodiment, the fish cage comprises multiple controllable ports, wherein at least one controllable port is arranged in the body and at least one controllable port is arranged in the at least one wall element.

In an embodiment of the invention, the fish cage further comprises one or more buoyancy elements having a controllable buoyancy. By controlling the buoyancy of the buoyancy elements, lowering of the fish cage in the water body may be done without filling the spacing with water. In an embodiment, the fish cage may comprise multiple buoyancy elements arranged with even spacing around the fish cage. In another embodiment, the fish cage may comprise four buoyancy elements. In a further embodiment, the one or more buoyancy elements may extend from the bottom unit to a top portion of an uppermost wall element. In an even further embodiment, the bottom unit and each of the at least one wall elements may comprise a section of a buoyancy element, said sections forming a continuous buoyancy element.

The object of the invention is further obtained by means of use of a fish cage according to any of the above embodiments.

### BRIEF DESCRIPTION OF THE DRAWINGS

In the following is described examples of preferred embodiments illustrated in the accompanying drawings, wherein:

FIG. 1 shows a fish cage assembled according to the invention;

FIG. 2a shows a step in the assembly of the fish cage according to an embodiment of the invention;

FIG. 2b shows a step in the assembly of the fish cage according to another embodiment of the invention;

FIG. 3a shows another step in the assembly of the fish cage according to the embodiment in FIG. 2a;

FIG. 3b shows another step in the assembly of the fish cage according to the embodiment in FIG. 2b;

FIG. 4a shows a further step in the assembly of the fish cage according to the embodiment in FIG. 3a;

FIG. 4b shows a further step in the assembly of the fish cage according to the embodiment in FIG. 3b;

FIG. 5a shows a further step in the assembly of the fish cage according to the embodiment in FIG. 4b;

FIG. 5b shows a fish cage assembled according to the embodiment in FIGS. 2b, 3b, 4b and 5a;

FIG. 6 shows a step in the assembly of the fish cage according to a further embodiment of the invention;

FIG. 7 shows several fish cages being transported on a vessel;

FIG. 8a shows an embodiment of a bottom unit with a body shaped as a downwards pointing cone;

FIG. 8b shows an embodiment of a bottom unit with a body shaped as an upwards pointing cone;

FIG. 9 shows an embodiment of the bottom unit comprising four buoyancy elements, and

FIG. 10 shows an embodiment of the fish cage comprising four buoyancy elements.

### DETAILED DESCRIPTION OF THE DRAWINGS

The figures are depicted in a simplified manner, and details that are not relevant to illustrate what is new with the invention may have been excluded from the figures. The different elements in the figures may necessarily not be shown in the correct scale in relation to each other. Equal reference numbers refer to equal or similar elements.

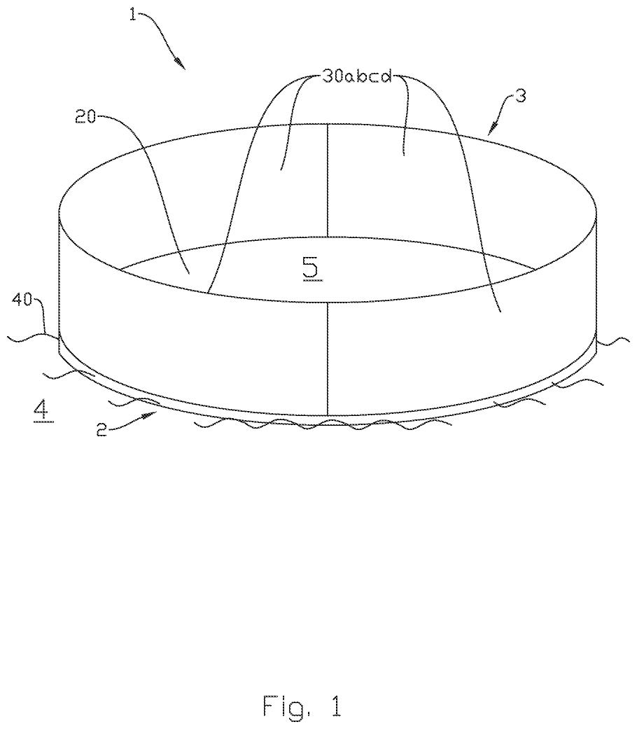

FIG. 1 shows a fish cage 1 assembled according to the invention, the fish cage 1 floating on the surface 40 of a water body 4. The fish cage 1 comprises a bottom unit 2 and a wall 3 formed by four wall elements 30a,b,c,d connected to a body 20 of the bottom unit 2. Each of the four wall elements 30a,b,c,d are also connected to an adjacent wall element 30a,b,c,d. The body and the wall elements 30a,b,c,d define a spacing 5 impermeably separated from the water body 4.

The bottom unit 2 comprises a rigid material such as steel, fibreglass or concrete. The bottom unit 2 is fabricated as one solid element but may also be fabricated as a truss work of beams covered by plates or a watertight cloth (not shown). In an embodiment, the body 20 comprises a watertight flexible material such as synthetic rubber or plastic (not shown). The body 20 may be stretched out inside or over a truss work of beams (not shown).

The bottom unit 2 is kept floatable by its shape. Thus, the weight of water displaced by a submerged portion of the bottom unit 2 exceeds the weight of the bottom unit 2. In another embodiment, the bottom unit 2 comprises air-filled voids (not shown) creating additional buoyancy. The voids are located between an underside and an upper side of the bottom unit 2. In an embodiment, the bottom unit 2 comprises floatable materials such as Styrofoam to further increase the buoyancy.

The wall elements 30a,b,c,d also comprise a rigid material such as steel, fibreglass or concrete. The wall elements 30a,b,c,d may comprise a truss work of beams covered by plates or a watertight cloth.

The wall elements 30a,b,c,d comprise a first receiving element (not shown) and the body 20 comprises a second receiving element (not shown). The first receiving element and the second receiving element are connected to form the connection between the wall elements 30a,b,c,d and the body 20. The connection forms a watertight seal between the spacing 5 and the water body 4. The receiving elements may be a threaded bolt and a complementary threaded hole, a bolt and a nut, a pin and a hole or other types of elements configured to be connected. In one embodiment, the receiving elements may be flanged struts configured to be connected. The wall elements 30a,b,c,d and the body 20 may also be welded to form a permanent connection. The connection between adjacent wall elements 30a,b,c,d may be similar to the connection between the wall elements 30a,b,c,d and the body 20.

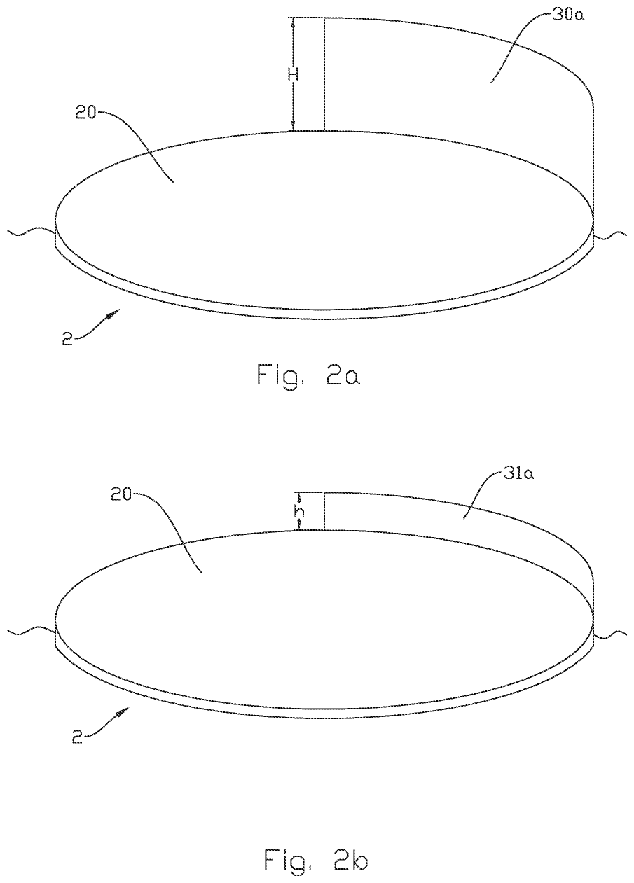

FIGS. 2a and 2b show a step in the assembly of the fish cage 1 wherein a first wall element 30a, 31a is connected to the body 20 of the bottom unit 2. FIG. 2a shows an embodiment of the invention where the wall element 30a has a height H equal a full height of the assembled fish cage 1. FIG. 2b shows an embodiment of the invention where the wall element 31a has a height h equal to a portion of the full height of the assembled fish cage 1.

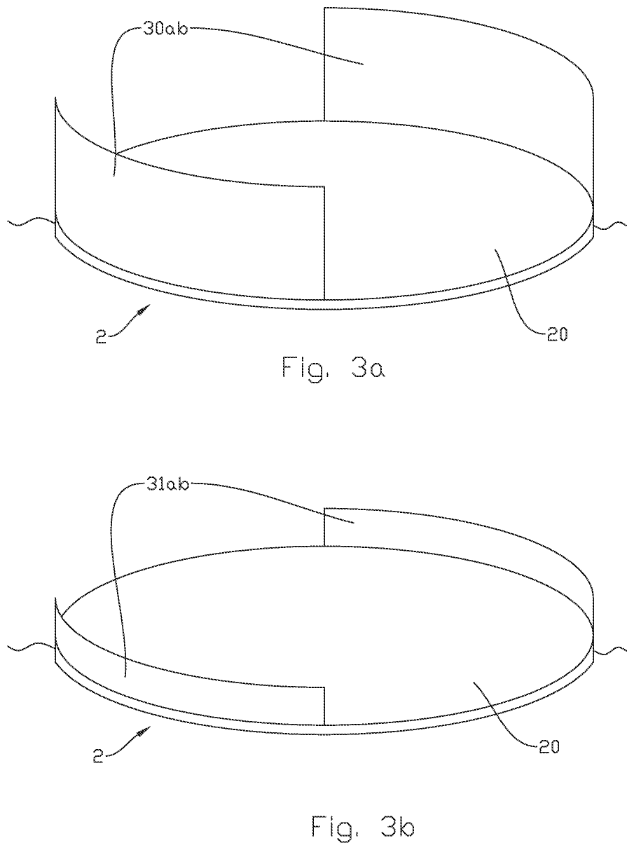

FIGS. 3a and 3b show another step in the assembly of the fish cage 1 wherein a second wall element 30b, 31b is connected to the body 20 of the bottom unit 2. The height of the wall elements 30b, 31b are similar to that of the wall elements 30a, 31a in FIGS. 2a and 2b respectively.

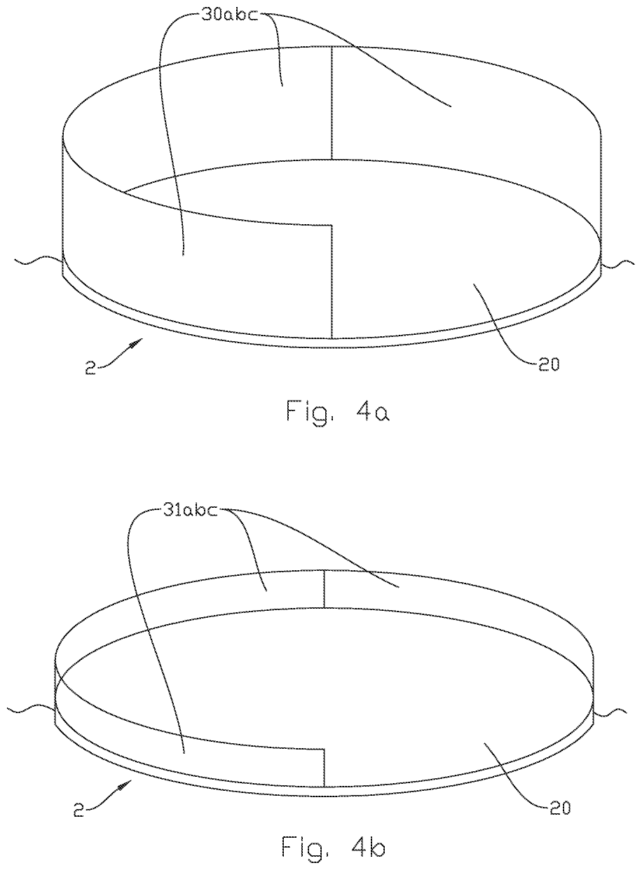

FIGS. 4a and 4b shows a further step in the assembly of the fish cage 1 wherein a third wall element 30c, 31c is connected to the body 20 of the bottom unit 2. The third wall elements 30c, 31c are also connected to first wall element 30a, 31a and second wall element 30ab, 31b. The height of the wall elements 30c, 31c are similar to that of the wall elements 30a, 31a in FIGS. 2a and 2b respectively.

FIG. 1 shows the assembled fish cage 1 of the embodiment in FIGS. 2a, 3a, and 4a, wherein a fourth wall element 30d is connected to the body 20 of the bottom unit 2 and the adjacent wall elements 30a, 30b.

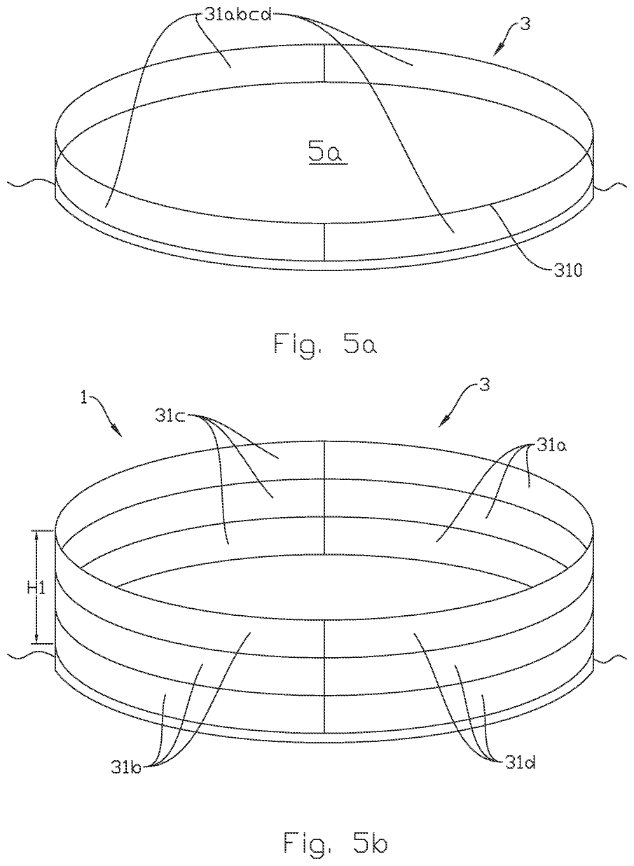

FIG. 5a shows a further step in the assembly of the fish cage 1 according to the embodiment in FIGS. 2b, 3b, and 4b, wherein a fourth wall element 31d is connected to the body 20 of the bottom unit 2 and the adjacent wall elements 31a, 31b. FIG. 5b shows an assembled fish cage 1 comprising three rows of wall elements 31a,b,c,d. A height H1 of the fish cage 1 in FIG. 5b may be similar to or different from that of the wall element 30a in FIG. 2a.

After the connection of each row of wall elements 31a,b,c,d the bottom unit 2 and the already connected wall elements 31a,b,c,d may be lowered at least partly in the water body 4. This enables the consecutive row of wall elements 31a,b,c,d to be connected at the same elevation above the water surface 40 as the previous row of wall element 31a,b,c,d. Lowering the bottom unit 2 and the connected wall elements 31a,b,c,d may be done by filling a partial spacing 5a defined by the bottom unit 2 and the connected wall elements 31a,b,c,d.

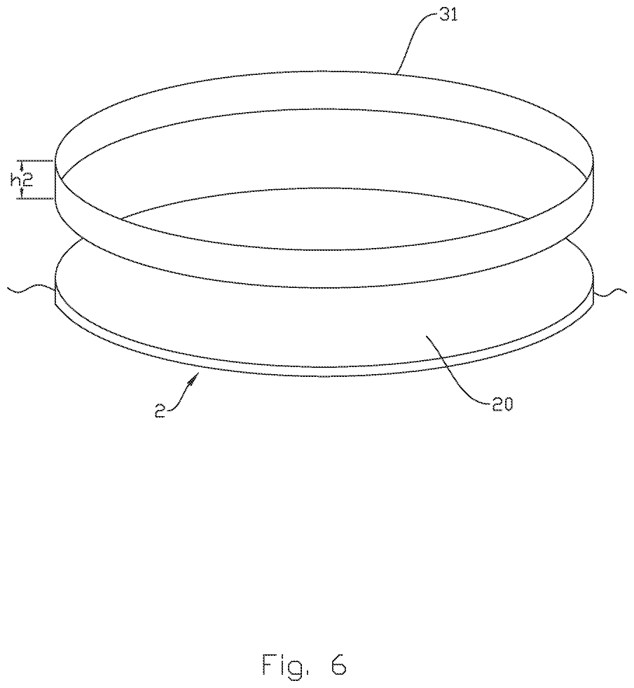

FIG. 6 shows a step in the assembly of the fish cage 1 according to a further embodiment of the invention, wherein a first wall element 31 is to be connected to the body 20 of the bottom unit 2. When connected to the body 20, the first wall element 31 forms a continuous circumferential wall around the body 20. It should be understood that in another embodiment, the body 20 and the wall element 31 may form a plane shape different from circular, such as square, rectangular, hexagonal or another shape. A height h2 of the wall element 31 may be similar to the height H of the wall element 30a in FIG. 2a, the height h of the wall element 31a in FIG. 2b, or it may be another height. In one embodiment, several wall elements 31 may be connected on top of each other.

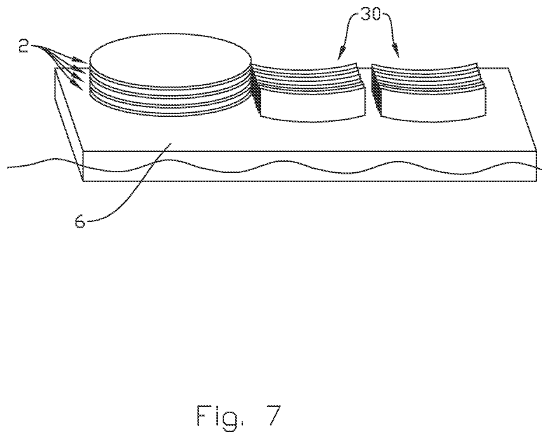

FIG. 7 shows four bottom units 2 and sixteen wall elements 30 being transported on a floating vessel 6. The bottom units 2 and the wall elements 30 may be assembled into four fish cages 1. The bottom units 2 are shown to be stacked on top of each other and the wall elements 30 are placed next to each other.

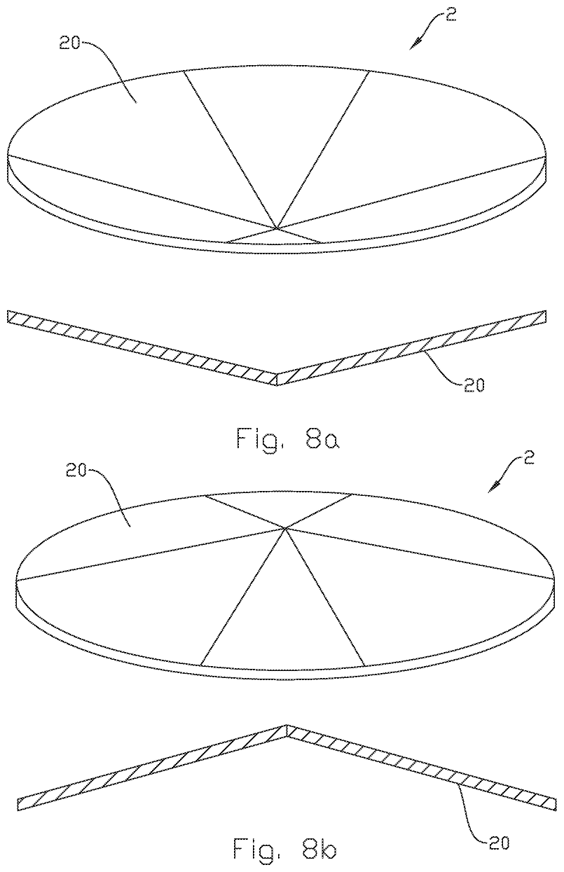

FIG. 8a shows an embodiment of the bottom unit 2 wherein the body 20 forms a downwards pointing cone, in an operable position. The figure shows a perspective view of the bottom unit 2 and a cross-section of the body 20. FIG. 8b shows an embodiment of the bottom unit 2 wherein the body 20 forms an upwards pointing cone, in an operable position. The figure shows a perspective view of the bottom unit 2 and a cross-section of the body 20. It should be understood that the shape of the body 20 is not limited to these embodiments, but that it may form a different shape, for example flat, in another embodiment.

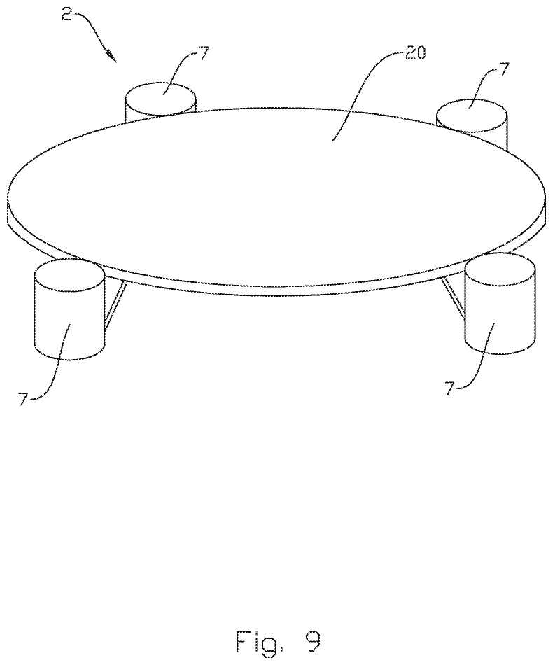

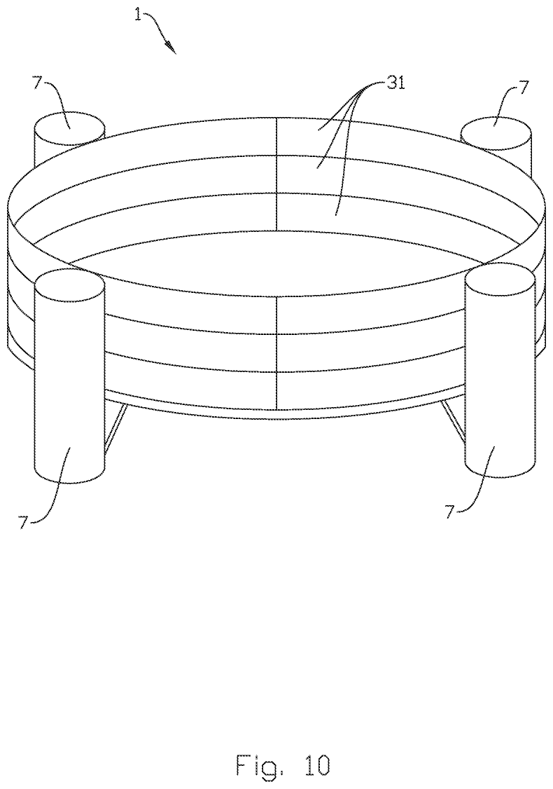

FIG. 9 shows an embodiment of the bottom unit 2 comprising four buoyancy elements 7. The buoyancy elements 7 are shown to be evenly distributed around the body 20. FIG. 10 shows an embodiment of the fish cage 1 comprising four buoyancy elements 7, wherein the buoyancy elements 7 extends upwards along the wall elements 31. The buoyancy elements 7 are shown to extend to the same height as the wall elements 31. The buoyancy elements 7 may extend to a different height in another embodiment.

The buoyancy elements 7 have a controllable buoyancy, meaning that a buoyancy force acting on the buoyancy elements 7 may be adjusted. In one embodiment, the buoyancy elements 7 are filled or drained for water to adjust their buoyancy.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1.-16. (canceled)

17. A method for assembly of a fish cage, the fish cage comprising a bottom unit having a buoyancy exceeding a weight of the bottom unit, the bottom unit being fabricated as one rigid element and comprising a body configured impermeable to water and at least one wall element configured impermeable to water, the method comprising:
providing the bottom unit on a surface of a water body;
connecting the at least one wall element to the body, thereby defining a spacing impermeably separated from the water body,
wherein the bottom unit comprises one or more buoyancy elements having a controllable buoyancy; and
altering a draught of the bottom unit and the at least one wall element connected to the body by controlling the buoyancy of the one or more buoyancy elements.

18. The method according to claim 17, wherein the at least one wall element comprises a first receiving element and the body comprises a second receiving element, and wherein the method comprises a step of displacing the at least one wall element to the body so that the first receiving element engages with the second receiving element.

19. The method according to claim 17, wherein the method comprises lowering the bottom unit and the at least one wall element connected to the body at least partly in the water body by filling water in the spacing.

20. The method according to claim 19, further comprising altering a draught of the bottom unit and the at least one wall element connected to the body by changing a water level in the spacing.

21. The method according to claim 17, further comprising connecting at least one further wall element to a wall element already connected to the body.

22. The method according to claim 17, further comprising transporting the bottom unit and the at least one wall element to an installation site by means of a vessel.

23. A kit of parts for assembling a fish cage, the kit of parts comprising:
a bottom unit being fabricated as one rigid element, and having a buoyancy exceeding a weight of the bottom unit, wherein the bottom unit comprises a body being impermeable to water, and one or more buoyancy elements having a controllable buoyancy; and
at least one wall element being impermeable to water, the at least one wall element being configured to be connected with the body, thereby defining a spacing impermeably separated from a water body.

24. The kit of parts according to claim 23, wherein the body comprises a first receiving element and the at least one wall element comprises a second receiving element configured to engage with the first receiving element, thereby forming a connection.

25. The kit of parts according to claim 23, wherein said body comprises a controllable port configured to provide liquid communication between said spacing and the water body.

26. A fish cage comprising:
a bottom unit having a buoyancy exceeding a weight of the bottom unit, the bottom unit being fabricated as one rigid element, and comprising a body configured impermeable to water, and one or more buoyancy elements having a controllable buoyancy; and
at least one wall element configured impermeable to water, the at least one wall element being connected to the body, thereby defining a spacing impermeably separated from a water body.

27. The fish cage according to claim 26, wherein the body comprises a first receiving element and the at least one wall element comprises a second receiving element in engagement with the first receiving element, thereby forming a connection.

28. The fish cage according to claim 26, further comprising a controllable port arranged in the body configured to provide liquid communication between the spacing and the water body.
